(19) United States
(12) Patent Application Publication
(10) Pub. No.: US 2019/0191937 A1
(43) Pub. Date: Jun. 27, 2019

(54) MULTI-HEADED PERSONAL CARE ASSEMBLY

(71) Applicant: L'Oreal, Paris (FR)

(72) Inventor: Scott S. Straka, Redmond, WA (US)

(73) Assignee: L'Oreal, Paris (FR)

(21) Appl. No.: 15/851,454

(22) Filed: Dec. 21, 2017

(51) Int. Cl. A47K 7/04; A46B 5/00; A46B 13/04; A46B 5/02; A46B 9/02; A61H 7/00

(52) U.S. Cl. CPC A47K 7/043; A46B 5/0095; A46B 13/04; A46B 5/021; A46B 9/023; A46B 9/021; A61H 2201/0153; A61H 7/005; A46B 2200/1006; A46B 2200/104; A46B 2200/1046; A61H 2201/1671; A61H 2201/1215; A46B 5/0016

(57) ABSTRACT

A multi-headed personal care assembly includes an appliance having at least first and second drive assemblies configured to selectively oscillate at least first and second personal care portions. An interface assembly is configured to removably attach two or more personal care portions to two or more drive assemblies of an appliance, wherein the two or more drive assemblies are configured to selectively oscillate the two or more personal care portions. A method of treating an application surface includes removably attaching a first personal care portion to an appliance, removably attaching a second personal care portion to the appliance, and selectively oscillating the first and second personal care portions in response to one or more inputs.

### SUMMARY

A multi-headed personal care assembly includes an appliance having at least first and second drive assemblies configured to selectively oscillate at least first and second personal care portions.

An interface assembly is configured to removably attach two or more personal care portions to two or more drive assemblies of an appliance, wherein the two or more drive assemblies are configured to selectively oscillate the two or more personal care portions.

In one aspect, the interface assembly further includes a pop-out assembly configured to protrude at least one of the two or more personal care portions from the appliance for use.

A method of treating an application surface includes removably attaching a first personal care portion to an appliance, removably attaching a second personal care portion to the appliance, and selectively oscillating the first and second personal care portions in response to one or more inputs.

In one aspect, the method further includes oscillating the first personal care portion at a first frequency and oscillating the second personal care portion at a second frequency.

In one aspect, the method further includes oscillating the first personal care portion out of phase with the second personal care portion.

In one aspect, the method further includes oscillating the first and second personal care portions at around 75 Hz.

In one aspect, the method further includes oscillating the first personal care portion in phase with the second personal care portion.

In one aspect, the method further includes protruding at least one of the first personal care portion and the second personal care portion in response to one or more inputs.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1a is an isometric view of a multi-headed personal care assembly shown in accordance with an exemplary embodiment of the present disclosure;

FIG. 1b is a top view of the multi-headed personal care assembly of FIG. 1a;

FIG. 1c is a cross-sectional view of the multi-headed personal care assembly of FIG. 1b, taken substantially across line 1c-1c;

FIG. 2a is an isometric view of a multi-headed personal care assembly shown in accordance with an alternative exemplary embodiment of the present disclosure;

FIG. 2b is a top view of the multi-headed personal care assembly of FIG. 3a;

FIG. 3 is a top view of a multi-headed personal care assembly shown in accordance with another alternative exemplary embodiment of the present disclosure;

FIG. 4 is a side view of a multi-headed personal care assembly shown in accordance with another alternative exemplary embodiment of the present disclosure; and

FIG. 5 is a functional block diagram of several operational components of the multi-headed personal care assembly of FIG. 1.

### DETAILED DESCRIPTION

Personal care appliances have been designed for cleansing, massaging, infusing product into, exfoliating, or otherwise treating the teeth, face, body, or other keratinous materials or areas. Some appliances include removable and/or replaceable personal care portions, such as brush heads, infusion tips, exfoliating discs, etc., that are oscillated over an area for treatment of that area.

In personal care appliances having oscillating brush heads, a fundamental goal is improved skin cleansing through mechanical oscillation of brush filament tips at the skin surface. While much effort has been expended on optimizing bristle properties (length & diameter, tip geometry, materials, colors, patterns, etc.) and/or brush oscillation amplitudes, neither addresses the number of actual moving bristle tips in contact with the skin. In other words, one aspect of skin cleansing is essentially a surface area problem. Cleansing a small area (e.g. face ˜400 cm²) in a shorter time (such as less than 1 minute) or a much larger area (e.g. body ˜1.6-2.0 m²) in an acceptable amount of time (such as about a 3-minute shower) compared to prior art devices requires more moving bristle tips in contact with the skin area.

For multiple reasons, the brush heads cannot simply be enlarged to increase the contact surface area of the bristle tips with the skin. For facial cleansing, the varying contours of the human face require a smaller brush head, generally less than 20-30 mm in diameter. In addition, the greatly increased rotational inertia of a larger brush head, such as for body cleansing requires excessive battery power, and it generates a counter torque to the handle that results in unpleasant hand vibration.

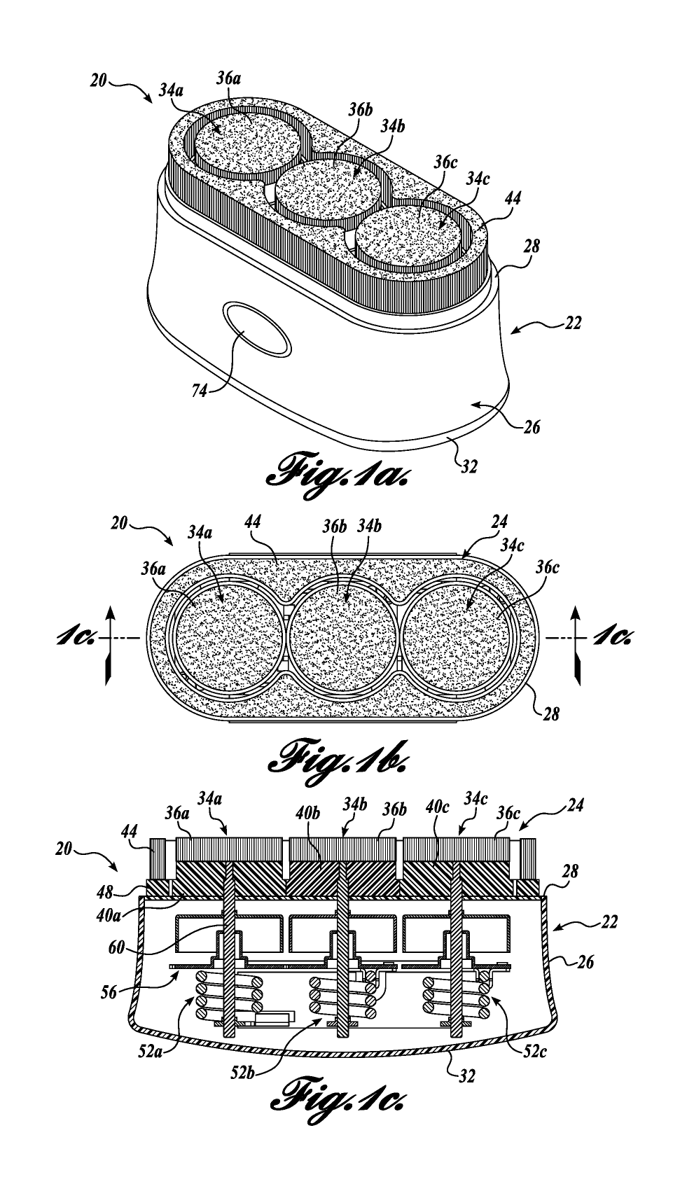

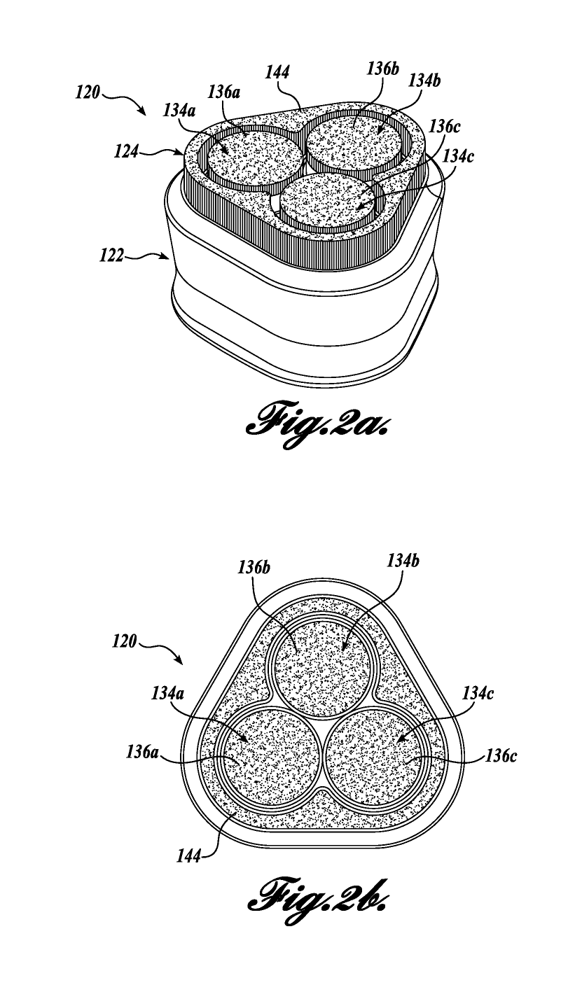

FIGS. 1a-1c depict an exemplary embodiment of a multi-headed personal care assembly 20 configured to provide an increased contact surface area for treating the skin without compromising the ability to treat contoured areas of the skin, and without causing excess hand vibration during use or compromising performance. Other advantages and benefits of the multi-headed personal care assembly 20 will become appreciated from the description that follows.

The multi-headed personal care assembly 20 generally includes an appliance 22 configured with a removable head assembly 24 suitable for cleansing, exfoliating, or otherwise treating a subject's skin. The appliance 22, which may be employed to impart an oscillating or other driving motion to the removable head assembly 20, will first be described in some detail. However, it should be appreciated that the removable head assembly 24 may instead be incorporated onto any suitable appliance, and accordingly, the descriptions and illustrations provided herein should not be seen as limiting the scope of the claimed subject matter.

The appliance 22 includes a handle portion 26 configured to be graspable by a user, a head attachment portion 28 defined at an upper end of the handle portion 26, and an end cap portion 32 defined opposite the head attachment portion 28. The appliance 22 is of any suitable contour, shape, size, geometry, etc., that is suitably graspable by the user for the intended application. For instance, in the embodiment depicted in FIGS. 1a-1c, the body 22 is generally elliptical in overall shape from a top or bottom view (see FIG. 1b). The handle portion 26 curves gently inwardly (i.e., concave) as it extends downwardly from the head attachment portion 28 toward the end cap 32. The end cap 32 may be substantially flat or gently curved to allow a user to set the multi-headed personal care assembly 20 on a surface when not in use, but still provide a contoured surface against which a user's hand may conform during use. Of course, any other suitable contour, shape, size, geometry, etc., may instead be used.

The head attachment portion 28 is configured to selective attach a removable head assembly to the body 22, such as removable head assembly 24. The exemplary head assembly 24 is removably attachable to the appliance 22 and includes a plurality of personal care portions, such as first, second, and third personal care portions 34a, 34b, and 34c that can be oscillated or otherwise moved over a subject's skin in order to clean, exfoliate, or otherwise treat the skin. As noted above, in the depicted embodiment, the body 22 is generally elliptical in overall shape from a top or bottom view. As such, the personal care portions 34a, 34b, and 34c are generally arranged in a linear row along the elliptical length of the body 22 with the second personal care portion 34b disposed between the first and third personal care portions 34a and 34c. However, any other suitable arrangement may instead be used.

In the depicted embodiment, the personal care portions 34a, 34b, and 34c are embodied as first, second, and third inner bristle assemblies 36a, 36b, and 36c respectively, extending from and secured to an exterior surface of first, second, and third inner bases 40a, 40b, and 40c, respectively, in a manner well known in the art. The inner bristle assemblies 36a, 36b, and 36c may be surrounded by a fixed outer guard 44 extending from and secured to an exterior surface of an outer base 48. The outer guard 44 may be configured as a bristle assembly, as shown in FIGS. 1a-1c, or alternatively as an elastomeric member (that can optionally be heated or cooled) or another suitable configuration.

In the depicted embodiment, the outer guard 44 is substantially the same size and shape as the head attachment portion 28. In other words, the outer guard 44 is substantially elliptical in shape from a top view (see FIG. 1b). Moreover, the outer guard 44 includes an inner opening 46 that substantially conforms in overall shape and size to the combined shape of the inner bristle assemblies 36a, 36b, and 36c. The outer guard 44 remains substantially fixed or stationary relative to the oscillating first, second, and third inner bristle assemblies 36a, 36b, and 36c such that it acts as somewhat of an outer splash guard.

The inner bristle assemblies 36a, 36b, and 36c are any suitable configuration for cleansing, exfoliating, massaging, etc., a desired area of the skin. For instance, one or more of the bristle assemblies may be similar in configuration to those described and illustrated in U.S. Pat. No. 8,641,702, entitled “System for treatment of skin conditions using at least one narrow band light source in a skin brush having an oscillating brush head,” filed on Jan. 4, 2008; U.S. Pat. No. 7,320,691, entitled “Apparatus and method for acoustic/mechanical treatment of early stage acne,” filed on Jan. 15, 2003; U.S. Pat. No. 8,484,788, entitled “Brush head for electric skin brush appliance,” filed on Mar. 14, 2011; U.S. Pat. No. 9,107,486, entitled “Exfoliating Brush Head for a Personal Care Appliance,” filed on Apr. 12, 2013; U.S. Pat. No. D711656, entitled “Exfoliating Disc Head”, filed Apr. 12, 2013; U.S. Pat. No. D715553, “Exfoliating Brush Head Assembly,” filed on Apr. 12, 2013; International Patent Application No. PCT/IB2013/002427, entitled “Brush head for Skin Brush Appliance,” filed Nov. 1, 2013; U.S. Patent Application Publication No. 20150065927, entitled “Brush With Multi-Height Bristles”, filed Aug. 18, 2014; U.S. Patent Application Publication No. 20150065927, entitled “Brush With Multi-Height Bristles,” filed Aug. 18, 2014; U.S. Patent Application Publication No. 20170119144, filed on Dec. 13, 2016, the disclosures of which are incorporated by reference in their entirety. Other suitable brush head assemblies, bristle configurations, etc., may instead be used.

As can be appreciated from the foregoing, many different bristle configurations and/or combinations of bristle configurations may be used. For instance, one or more inner bristle assemblies 36a, 36b, and/or 36c may be configured for sensitive skin cleansing, deep pore cleansing, acne treatment, exfoliating, brightening, etc. Moreover, the removable head assembly 24 may include a variety of different types of inner and/or outer bristle assemblies. For instance, a user with sensitive skin may also want to use a brush head for deep pore cleansing. For such a use, the removable head assembly 24 may include a first inner bristle assembly of a sensitive skin configuration, a second inner bristle assembly of a deep pore cleansing configuration, and a third inner bristle assembly of a sensitive skin configuration. The combined combination of sensitive and deep pore cleansing bristle configurations may cooperatively act to deeply clean a sensitive area of a user's skin. Any of the inner and/or outer bristle assembly configurations of the brush heads available from Pacific Bioscience Laboratories Inc. (DBA Clarisonic) of Redmond, Wash., which are configured for various uses, may be used on the removable head assembly 24.

Moreover, the removable head assembly 24 may include personal care portions 34a, 34b, and 34c having configurations other than bristle assemblies, such as exfoliating discs, infusion tips, hair brushes, sponges, massaging heads, etc. For instance, the personal care portions 34a, 34b, and 34c may include one or more exfoliating discs similar to one or more of those described and illustrated in U.S. Pat. No. 9,750,533, entitled “Exfoliating head for a personal care appliance”, filed on Apr. 12, 2013; U.S. Pat. No. D698449, entitled “Exfoliating Disc Head”, filed Apr. 12, 2013; U.S. Pat. No. D698932, entitled “Exfoliating Disc Head”, filed Apr. 12, 2013, the disclosures of which are incorporated by reference in their entirety. As another example, the personal care portions 34a, 34b, and 34c may include one or more infusion tips similar to one or more of those described and illustrated in U.S. Patent Application Publication No. 20100300479, entitled “Applicator tip assembly for skin formulation applicator,” the disclosure of which is incorporated by reference in its entirety.

Any of the exfoliating discs, infusion tips, massaging heads, or other “brush heads”, available from Pacific Bioscience Laboratories Inc. (DBA Clarisonic) of Redmond, Wash., may also be used as one or more portions of the personal care portions 34a, 34b, and 34c. Moreover, the personal care portions 34a, 34b, and 34c may be all the same configuration type (i.e., all brush head assemblies, all exfoliating disc, all infusion tips, etc.), or the personal care portions 34a, 34b, and 34c may instead include a combination of two or more different configuration types. Further, the personal care portions 34a, 34b, and 34c may instead be configured to treat materials other than a subject's body, such as clothing, food, etc.

The interior surface of each of the first, second, and third inner bases 40a, 40b, and 40c, of the first, second, and third inner bristle assemblies 36a, 36b, and 36c, respectively, are securable to or are otherwise configured to interface with first, second, and third drive assemblies 52a, 52b, and 52c disposed within the appliance 22 for selective oscillation or otherwise driving of the inner bristle assemblies 36a, 36b, and 36c. The inner bases 40a, 40b, and 40c may interface with the drive assemblies 52a, 52b, and 52c through a suitable connecting structure, locking assembly, etc., which may be dependent on the type of drive assembly used. For instance, the interior surface of each inner base 40a, 40b, and 40c may be securable on a hub 64 that is configured to interface with the drive assemblies 52a, 52b, and 52c, such as the hub shown and described in U.S. Pat. No. 7,386,906, entitled “Oscillating Brush head Attachment System for a Personal Care Appliance,” filed Jun. 22, 2004, the entire disclosure of which is incorporated by reference herein.

In another embodiment, the inner bases 40a, 40b, and 40c each interface with the drive assemblies 52a, 52b, and 52c through a suitable “floating” connecting structure that allows the first, second, and third inner bristle assemblies 36a, 36b, and 36c, respectively, to adapt to the contour of the treatment surface during use. For instance, the floating connecting structure may allow the inner bases 40a, 40b, and 40c to move along the z-axis direction (i.e., along the axis of the drive shaft) through elastomeric structure or the like, while maintaining rotational rigidity for suitably translating the oscillations of the motor to the inner bases 40a, 40b, and 40c.

In yet other embodiments, the inner bases 40a, 40b, and 40c may instead be permanently secured to the drive shafts of the drive assemblies 52a, 52b, and 52c, respectively while optionally providing for movement in the z-axis.

Each drive assembly 52a, 52b, and 52c in some embodiments includes an electric drive motor 56 (only labeled for the first drive assembly 52a) that drives an attached head, such as one of the personal care portions 34a, 34b, or 34c, via a drive shaft or armature 60. Each drive assembly 52a, 52b, and 52c may be configured to operate a personal care portion at sonic frequencies, typically in the range of 80-160 Hz, oscillating the personal care portion back and forth within a range or amplitude of 3-20 degrees. In some embodiments, the personal care portion is operated in loaded or unloaded conditions at frequencies between about 80 Hz to 120 Hz with an amplitude or range of about 3-17 degrees. In other embodiments, the personal care portion is operated in a loaded condition at frequencies of about 94 Hz to 106 Hz, amplitudes of about 8-12 degrees, and a duty cycle of about 38-44%.

One example of a drive assembly that may be employed by the multi-headed personal care assembly 20 to oscillate each personal care portion is shown and described in U.S. Pat. Nos. 7,786,626 and 7,157,816, as well as U.S. Patent Application Publication No. US20090306577A1, the disclosures of which is hereby incorporated by reference in its entirety. However, it should be understood that this is merely an example of the structure and operation of one such appliance and that the structure, operation, frequency and oscillation amplitude of such an appliance could be varied, depending in part on its intended application and/or characteristics of the head, such as its inertial properties, etc. In some embodiments of the present disclosure, the frequency ranges are selected so as to drive the attached head at near resonance. Thus, selected frequency ranges are dependent, in part, on the inertial properties of the attached head. It will be appreciated that driving the attached head at near resonance provides many benefits, including the ability to drive the attached head at suitable amplitudes in loaded conditions (e.g., when contacting the skin).

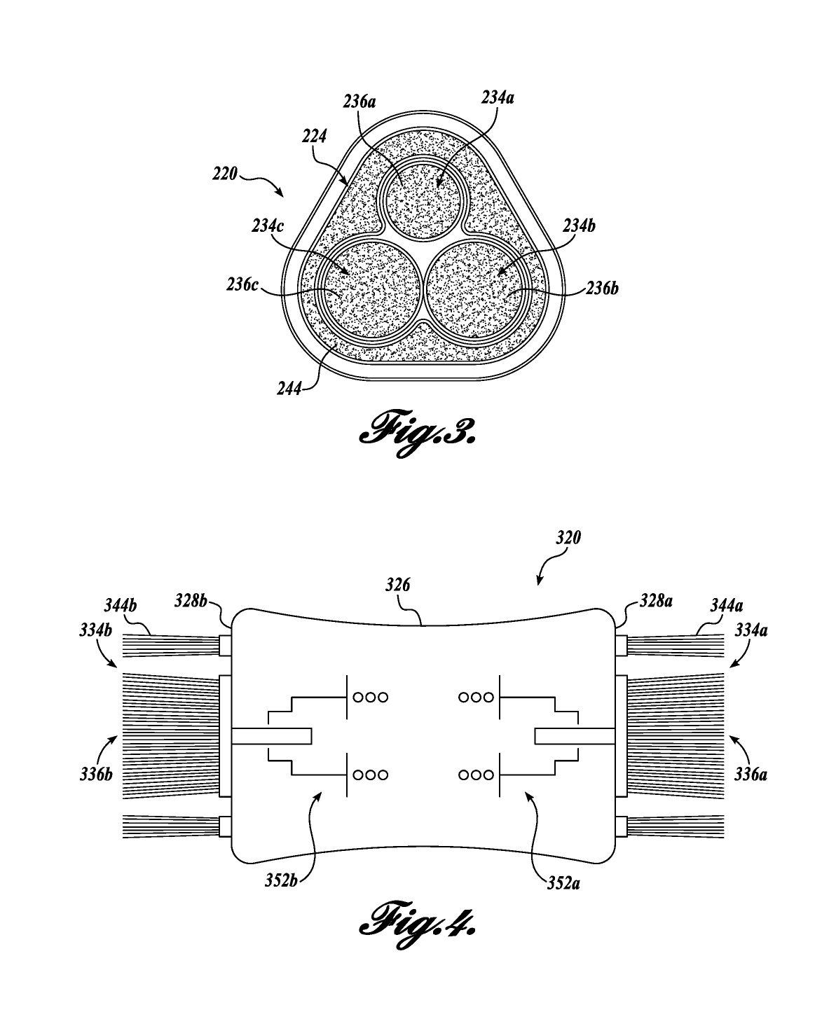

FIGS. 2a-2b depict an alternative exemplary embodiment of a multi-headed personal care assembly 120 that is substantially similar to the multi-headed personal care assembly 20 described above except for the differences hereinafter noted is depicted. In that regard, similar parts are labeled with similar reference numerals except in the '100 series.

The multi-headed personal care assembly 120 generally includes an appliance 122 configured with a removable head assembly 124 suitable for cleansing, exfoliating, or otherwise treating a subject's skin. The appliance 122, however, is generally triangular (with soft corners) in overall shape from a top view (see FIG. 2b). In that regard, the personal care portions 134a, 134b, and 134c are in a generally triangular arrangement within the appliance 122.

The personal care portions 134a, 134b, and 134c may be configured as inner bristle assemblies 136a, 136b, and 136c, as described above with respect to the assembly 20, having an outer bristle assembly 144 surrounding the inner bristle assemblies 136a, 136b, and 136c. In the alternative, the personal care portions 134a, 134b, and 134c may be configured as an exfoliating disc, an infusion tip, etc. Suitable drive assemblies (not shown) similar to that described above with respect to assembly 20 may be disposed within the body 122 and configured to selectively oscillate the personal care portions 134a, 134b, and 134c.

FIG. 3 depicts another alternative exemplary embodiment of a multi-headed personal care assembly 220 that is substantially similar to the multi-headed personal care assembly 120 described above except for the differences hereinafter noted. In that regard, similar parts are labeled with similar reference numerals except in the '200 series.

The multi-headed personal care assembly 220 generally includes a triangular-shaped appliance 222 configured with a removable head assembly 224 suitable for cleansing, exfoliating, or otherwise treating a subject's skin. First, second, and third personal care portions 234a, 234b, and 234c are in a generally triangular arrangement within the appliance 222, similar to assembly 120; however, the second and third personal care portions 234b and 234c are larger in diameter than the first personal care portion 234a. It should be appreciated that the personal care portions having varied diameters or sizes may instead be arranged in any other suitable configuration. If the first, second, and third personal care portions 234a, 234b, and 234c are inner bristle assemblies, they may be surrounded by an outer bristle assembly 244.

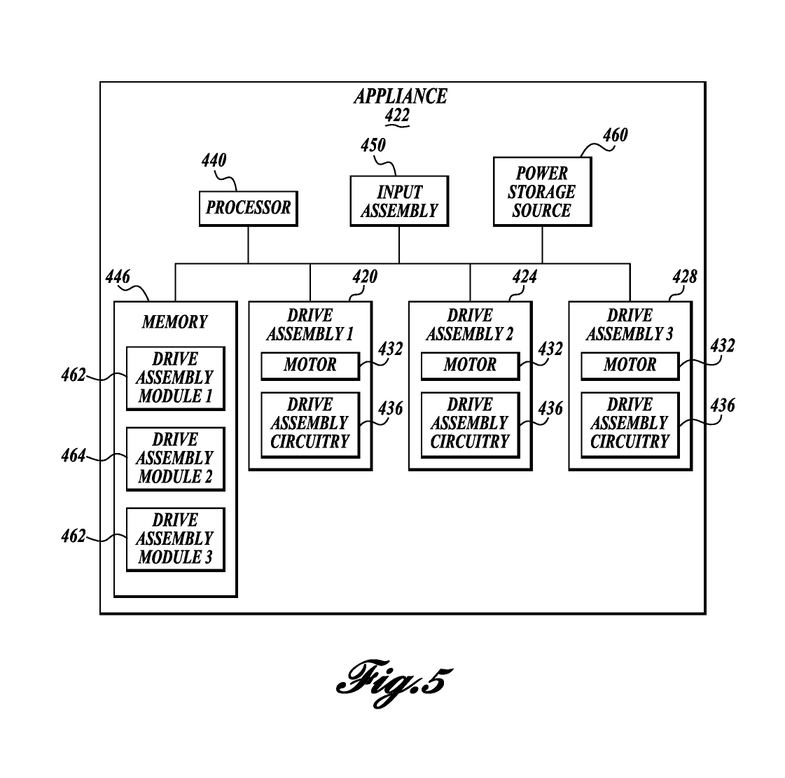

FIG. 4 depicts another alternative exemplary embodiment of a multi-headed personal care assembly 320 that is substantially similar to the multi-headed personal care assembly 20 described above except for the differences hereinafter noted. In that regard, similar parts are labeled with similar reference numerals except in the '300 series.

The multi-headed personal care assembly 320 generally includes an appliance 322 configured with first and second opposing removable head assemblies 324a and 324b that are suitable for cleansing, exfoliating, or otherwise treating a subject's skin. The appliance 322, is generally cylindrically shaped having first and second opposing head attachment portions 328a and 328b (at the first and second ends of appliance 122), and a generally concave shaped handle portion 326 extending between the first and second opposing head attachment portions 328a and 328b.

First and second opposing personal care portions 334a and 334b are removably attachable to the first and second head attachment portions 328a and 328b in a manner well known in the art. The personal care portions 334a and 334b may be configured as inner bristle assemblies 336a and 336b, as described above with respect to the assembly 20, having first and second outer bristle assemblies 344a and 344b, respectively surrounding the inner bristle assemblies 336a and 336b. In the alternative, the personal care portions 334a and 334b may be configured as an exfoliating disc, an infusion tip, etc.

First and second drive assemblies 352a and 352b are disposed within the appliance 22 for selective oscillation or otherwise driving of the personal care portions 334a and 334b. The drive assemblies 352a and 352b may be similar to the drive assemblies 52a, 52b, and 52c described above with respect to assembly 20 or any other suitable drive assembly.

With the personal care portions 334a and 334b configured in an opposite arrangement, one of the personal care portions 334a and 334b may be used independently of the other. In that regard, the multi-headed personal care assembly may include suitable operating structure for independently activating and/or controlling each personal care portion 334a and 334b. Moreover, each personal care portion 334a and 334b may be of a different configuration. For instance, the first personal care portion 334a may be configured as a bristle assembly, and the second personal care portion 334b may be an exfoliating disc, an infusion tip, etc. In such an embodiment, the assembly would be multi-functional. In other embodiments, the first personal care portion 334a may be configured as a first type of bristle assembly (such as sensitive skin cleansing), and the second personal care portion 334b may be configured as a second type of bristle assembly (such as deep pore cleansing).

It can be appreciated from the foregoing that a multi-headed personal care assembly formed in accordance with the present disclosure may be configured in any suitable manner. For instance, the multi-headed personal care assembly may have two, three, or four or more personal care portions. Moreover, the personal care portions may be arranged linearly, triangularly, spherically, as a square, or any other suitable arrangement.

Certain optional operational features of a multi-headed personal care assembly formed in accordance with an exemplary embodiment of the present disclosure will now be described. In that regard, an exemplary operating structure and associated internal assemblies of an appliance 422 of the multi-headed personal care assembly is shown in block diagrammatic form in FIG. 5. For ease of reference, the exemplary operating structure will be described with reference to an appliance substantially similar to appliance 22 shown in FIGS. 1a-1c, which is configured for use with first, second, and third personal care portions 34a, 34b, and 34c. However, it should be appreciated that the operating structure hereinafter described is exemplary only, and may be modified for any suitable multi-headed personal care assembly.

Referring to FIG. 5, the exemplary operating structure includes a programmed microcontroller or processor 440 configured to control the delivery of power to a plurality of drive assemblies, such as first, second and third drive assemblies 420, 424, and 428 or other aspects of the multi-headed personal care assembly, an input assembly 450 (which may include an on/off button, a power adjust button, a mode control button, etc., such as button 74 shown in FIG. 1), and a power storage source 460, such as a rechargeable battery. Further, the processor 440 is configured to operate in accordance with program instructions stored in a memory 446 or otherwise stored in hardware format for controlling aspects of the drive assemblies 420, 424, and 428 or other aspects of the multi-headed personal care assembly.

As illustrated in FIG. 5, in one embodiment the memory 146 stores a first drive assembly module 462, a second drive assembly module 464, and a third drive assembly module 466, wherein each module stores programs, files, etc., for activating and/or controlling the first, second and third drive assemblies 420, 424, and 428. It should be appreciated that the first, second and third drive assembly modules 462, 464, and 468 may be instead be defined by a single module or more than three modules. Accordingly, any suitable programs and instructions for activating and/or controlling the first, second and third drive assemblies 420, 424, and 428 or other aspects of the multi-headed personal care assembly may be used.

Each drive assembly 420, 424, and 428 may include drive assembly circuitry 436 operably coupled to a motor 432 and configured for actuating and controlling the motor 432 to oscillate a corresponding personal care portion in the manner described above, or in any other suitable manner. The drive assembly circuitry 436 of each drive assembly can be configured to receive input from the input assembly 450, the processor 440, one or more modules stored in the memory 446, and/or from one of the other drive assemblies. For instance, the input assembly 450 may be configured and arranged to selectively deliver power from the power storage source 460 to the drive assembly when a user presses a button (such as button 74 shown in FIG. 1).

Each corresponding drive assembly module 462, 464, and 466 may include any suitable programs, files, or instructions for activating and controlling the first, second and third drive assemblies 420, 424, and 428 in response to one or more inputs. In some embodiments, one or more drive assembly modules 462, 464, and 466 may be configured to activate a selective number of the one or more drive assemblies 420, 424, and/or 428 in response to one or more inputs. For instance, a user may depress a button to select activation of only one of the plurality of personal care portions (and therefore only one of the drive assemblies) when only that selected personal care portion will be used.

In a non-limiting example, a multi-headed personal care assembly may have a first type of brush head for cleaning the skin and a second type of brush head for applying makeup, and the user can select (with an input button or otherwise) only one of the two brush heads to use. One or more of the drive assembly modules 462, 464, and 466 may activate the corresponding drive assembly for a predetermined amount of time in response to such an input signal (or processed signal). In addition, in response to such an input signal (or processed signal), one or more of the drive assembly modules 462, 464, and 466 may activate a pop-out assembly (not shown) for protruding the personal care portion of the selected drive assembly such that substantial interference with the other personal care portions does not occur during use. This configuration may be beneficial for treating a small or contoured area of the skin.

In some embodiments, one or more of the drive assembly modules 462, 464, and 466 may be configured to activate and control oscillation of the motors 432 of one or more drive assemblies 420, 424, and/or 428 in response to one or more inputs. For instance, a user may select (with an input button or otherwise) a particular appliance mode, such as maximum treatment mode, shear mode, fluid ejection mode, massaging mode, etc.

If a user selects maximum treatment mode, for instance, one or more of the drive assembly modules 462, 464, and 466 may activate all of the drive assemblies 420, 424, and 428 for a predetermined amount of time in response to such an input signal (or processed signal). With all the personal care portions activated at the same time, a maximum surface area of the skin may be treated. If the personal care portions are brush heads, skin cleansing will be more efficient. In other words, the more bristles that are in contact with the skin, the more efficient the skin cleansing process will be.

If a user selects shear mode, for instance, one or more of the drive assembly modules 462, 464, and 466 may activate the first drive assembly 420 to oscillate a first personal care portion at a predetermined frequency starting in a first direction (such as clockwise), the second drive assembly 424 to oscillate a second personal care portion at a predetermined frequency starting in a second direction (such as counterclockwise), and the third drive assembly 428 to oscillate a third personal care portion at a predetermined frequency starting in the first direction (such as clockwise) for a predetermined amount of time in response to such an input signal (or processed signal). In other words, the first and third personal care portions will be oscillating out of phase with the second personal care portion. If the second personal care portion is positioned between the first and third personal care portions, as in the assembly of FIGS. 1a-1c, the out of phase oscillation of the personal care portions will impose a shear force on the application surface, such as the skin. In the example of using a brush head for skin cleansing, the shear force will help stretch the skin and further open the pores for deeper cleansing. Moreover, by oscillating the personal care portions out of phase, vibration of the appliance 422, and specifically its handle portion is reduced, thereby providing a more pleasant experience for the user.

However, in a fluid ejection mode, the user may instead purposefully choose an input to oscillate the personal care portions in phase. By oscillating the personal care portions in phase, an increased amount of fluid may be ejected from the personal care portion during use. For instance, if fluid ejection mode is selected with an assembly having multiple brush heads, a unique fluid cleansing experience will result from the increased fluid ejected from the brush heads during cleaning. The fluid cleansing experience is of course increased with multiple brush heads.

The shear force and fluid ejection effects of a brush head are further described in U.S. Patent Application Publication Nos. 20150182246, the entire disclosures of which are hereby incorporated by reference herein.

If a user selects massaging mode, for instance, one or more of the drive assembly modules 462, 464, and 466 may activate the first drive assembly 420 to oscillate a first personal care portion at a predetermined massaging frequency in a first direction (such as clockwise), the second drive assembly 424 to oscillate a second personal care portion at a predetermined massaging frequency in a second direction (such as counterclockwise), and the third drive assembly 428 to oscillate a third personal care portion at a predetermined massaging frequency in the first direction (such as clockwise) for a predetermined amount of time in response to such an input signal (or processed signal). With all the personal care portions activated at the same time and oscillating out of phase, a massaging effect of the skin may occur. Moreover, the inventors have found that when oscillation of a single personal care portion occurs at around 75 Hz, a massaging effect occurs. In particular, if the skin is stretched at around 75 Hz, collagen stimulation and fibrogen proteins are expressed, which can increase skin structure and decrease wrinkles. Accordingly, with multiple personal care portions oscillating out of phase at around 75 Hz, the massaging effect may be increased.

It should be appreciated that the one or more of the drive assembly modules 462, 464, and 466 may also be configured to activate or deactivate one or more of the drive assemblies or other features of the appliance 422 in response to other types of inputs. For instance, the drive assembly modules 462, 464, and 466 may be configured to activate a first drive assembly when a second and/or third drive assembly is deactivated. The drive assembly modules 462, 464, and 466 may be configured to activate the first drive assembly 420 at a first frequency (e.g., 75 Hz for a massaging effect), the second drive assembly 424 at a second frequency (e.g., 175 Hz for a cleansing effect), and the third drive assembly 428 at the first frequency (e.g., 75 Hz for a massaging effect) for an overall combined cleansing and massaging experience.

The drive assembly modules 462, 464, and 466 may also be configured to activate a vaporizer and vapor heating assembly that discharges a heated vapor (from the inner and/or outer brush head, the handle portion, etc.) when the module(s) receive an input signal indicating that at least one of the drive assemblies has been activated or in response to another input signal. For instance, the appliance may include a vaporizer and vapor heating assembly similar to that shown and described in U.S. patent application Ser. No. 15/476,352, filed Mar. 31, 2017, entitled “Vaporizing and Vapor Heating Assembly and Personal Care Appliances Including the Same”, the entire disclosure of which is hereby incorporated by reference herein. The drive assembly modules 462, 464, and 466 may be configured to activate other heating or cooling elements of the appliance when the module(s) receive one or more input signals.

The operating structure and associated internal assemblies may also have circuitry configured to exchange encrypted and anonymized multi-headed personal care assembly information with a remote network, circuitry configured to detect a client device associated with the multi-headed personal care assembly and to exchange encrypted and anonymized information with the client device, and/or circuitry configured to detect a client device associated with the multi-headed personal care assembly and to exchange drive assembly control information or other control information with the client device.

It should be appreciated that the operating structure and associated internal assemblies may have any suitable modules, circuitry, etc., configured to selectively activate and control features of the appliance to benefit from the combined effect of the multiple personal care portions.

The detailed description set forth above in connection with the appended drawings is intended as a description of exemplary embodiments of a multi-headed personal care assembly and are not intended to represent the only embodiments. The representative embodiments described in this disclosure are provided merely as an example or illustration and are not intended to be exhaustive or to limit the claimed subject matter to the precise forms disclosed.

In the foregoing description, numerous specific details are set forth in order to provide a thorough understanding of the exemplary embodiments of the present disclosure. It will be apparent to one skilled in the art, however, that the exemplary embodiments of the present disclosure may be practiced without some or all of the specific details. In some instances, well-known process steps or features have not been described in detail in order not to unnecessarily obscure various aspects of the present disclosure. Further, it will be appreciated that the exemplary embodiments of the present disclosure may employ any combination of features described herein.

The present disclosure may also include references to directions, such as “forward,” “rearward,” “front,” “back,” “upward,” “downward,” “lateral,” “medial,” “in,” “out,” “extended,” “advanced,” “retracted,” “vertical,” “horizontal,” “proximal,” “distal,” “central,” etc. These references, and other similar references in the present disclosure, are only to assist in helping describe and understand the particular embodiment and are not intended to limit the present disclosure to these directions or locations.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. In an embodiment, “about,” “approximately,” etc., means plus or minus 5% of the stated value.

While illustrative embodiments have been illustrated and described, it will be appreciated that various changes can be made therein without departing from the spirit and scope of the invention.

The embodiments of the invention in which an exclusive property or privilege is claimed are defined as follows:

1. A multi-headed personal care assembly, comprising an appliance having at least first and second drive assemblies configured to selectively oscillate at least first and second personal care portions.

2. The assembly of claim 1, wherein the at least first and second personal care portions are removably attachable to the appliance for selectively interfacing with the at least first and second drive assemblies.

3. The assembly of claim 1, wherein the first drive assembly is configured to selectively oscillate the first personal care portion out of phase with the oscillation of the second personal care portion.

4. The assembly of claim 3, wherein the first and second drive assemblies are configured to selectively oscillate the first and second personal care portions at around 75 Hz.

5. The assembly of claim 1, wherein the first drive assembly is configured to selectively oscillate the first personal care portion in phase with the oscillation of the second personal care portion.

6. The assembly of claim 1, wherein the first personal care portion is of a first configuration and the second personal care portion is of a second configuration.

7. The assembly of claim 6, wherein the first and second configurations are selected from a group consisting of a bristle assembly, an exfoliating disc, an infusion tip, a hair brush, a cosmetic applicator, a sponge, and a massaging head.

8. The assembly of claim 6, wherein the first and second configurations are selected from a group consisting of a sensitive skin cleansing bristle assembly, a deep pore cleansing bristle assembly, a brightening bristle assembly, an exfoliating bristle assembly, and an acne treatment bristle assembly.

9. The assembly of claim 1, wherein the first personal care portion is of a first size and the second personal care portion is of a second size different from the first size.

10. The assembly of claim 1, further comprising an interface assembly configured to removably attach the two or more personal care portions to the two or more drive assemblies.

11. The assembly of claim 10, wherein the interface assembly is further configured to allow movement of each of the two or more personal care portions along an axis of a drive shaft of each of the two or more drive assemblies.

12. The assembly of claim 1, further comprising a pop-out assembly configured to protrude at least one of the two or more personal care portions from the appliance for use.

13. The assembly of claim 1, further comprising drive assembly circuitry operably coupled to the two or more drive assemblies and configured to activate at least one of the two or more drive assemblies in response to one or more inputs.

14. The assembly of claim 13, wherein the drive assembly circuitry is configured to control the oscillation frequency and phase of each of the two or more drive assemblies.

15. The assembly of claim 1, further comprising circuitry configured to exchange encrypted and anonymized appliance information with a remote network.

16. The assembly of claim 1, further comprising circuitry configured to detect a client device associated with the appliance and to exchange encrypted and anonymized information with the client device.

17. The assembly of claim 1, further comprising circuitry configured to detect a client device associated with the appliance and to drive assembly control information with the client device.

18. An interface assembly configured to removably attach two or more personal care portions to two or more drive assemblies of an appliance, wherein the two or more drive assemblies are configured to selectively oscillate the two or more personal care portions.

19. The interface assembly of claim 18, further comprising means configured to allow movement of each of the two or more personal care portions along an axis of a drive shaft of each of the two or more drive assemblies while suitably translating oscillations from each drive shaft to the corresponding personal care portion.

20. A method of treating an application surface, comprising:
removably attaching a first personal care portion to an appliance;
removably attaching a second personal care portion to the appliance; and
selectively oscillating the first and second personal care portions in response to one or more inputs.
